(19) United States
(12) Patent Application Publication
(10) Pub. No.: US 2017/0050516 A1
(43) Pub. Date: Feb. 23, 2017

(54) TRANSFER FOR VEHICLE

(71) Applicant: Toyota Jidosha Kabushiki Kaisha, Toyota-shi Aichi-ken (JP)

(72) Inventor: Mizuki Imafuku, Kariya-shi Aichi-ken (JP)

(21) Appl. No.: 15/238,171

(22) Filed: Aug. 16, 2016

(30) Foreign Application Priority Data
Aug. 20, 2015 (JP) 2015-163272

(51) Int. Cl. B60K 17/346; F16H 48/22

(52) U.S. Cl. CPC B60K 17/3462; F16H 48/22

(57) ABSTRACT

A fork shaft arranged inside a rear-wheel side output shaft is connected to a high-low sleeve of a high-low switching mechanism and a nut member of a screw mechanism that adjusts torque of a front-wheel drive clutch, such that when the nut member moves in an axial direction of the rear-wheel side output shaft, the high-low sleeve moves in the axial direction in conjunction via the fork shaft. Therefore, switching of the high-low switching mechanism and torque adjustment of the front-wheel drive clutch are both able to be executed by the screw mechanism. The fork shaft is arranged inside an axial hole in the rear-wheel side output shaft.

### CROSS-REFERENCE TO RELATED APPLICATIONS

The present disclosure claims priority to Japanese Patent Application No. 2015-163272 filed on Aug. 20, 2015, which is incorporated herein by reference in its entirety including the specification, drawings and abstract.

### BACKGROUND

1. Technical Field

The disclosure relates to a transfer for a vehicle.

2. Description of Related Art

US 2007/0251345 A describes an FR-based four-wheel drive vehicle provided with a transfer that distributes power transmitted from an input rotating member to front wheels and rear wheels. The vehicle transfer described in US 2007/0251345 A includes a high-low switching mechanism that changes a rate of rotation input from an input shaft, and a multiple disc clutch that distributes a portion of the torque transmitted from the input shaft to the front wheels. In the vehicle transfer described in US 2007/0251345 A, the switching of the high-low switching mechanism and the torque adjustment of the multiple disc clutch are both executed by a single motor. Power from the motor is transmitted to the high-low switching mechanism and the multiple disc clutch, respectively, via a cam mechanism.

### SUMMARY

In the structure in which power from the motor is transmitted to the high-low switching mechanism and the multiple disc clutch via the cam mechanism, a shaft for transmitting the power from the motor to the cam mechanism is provided inside the vehicle transfer. Therefore, space for arranging the shaft is necessary, so the physical size of the vehicle transfer is large.

This disclosure provides a structure that enables a transfer that is provided with a high-low switching mechanism and a single disc or multiple disc clutch to be smaller.

An example aspect of the disclosure provides a transfer for a vehicle, the vehicle including first left and right wheels, second left and right wheels, and an electric motor. The transfer includes an input rotating member, a first output rotating member, a second output rotating member, a high-low switching mechanism, a clutch, a screw mechanism and a transmitting mechanism. The input rotating member is configured to rotate around an axis of the input rotating member. The first output rotating member is configured to output power to the first left and right wheels. The second output rotating member is configured to output power to the second left and right wheels. The high-low switching mechanism is configured to change a rate of rotation input from the input rotating member and transmit the resultant rotation to the first output rotating member. The high-low switching mechanism includes a high-low sleeve. The clutch is configured to transmit a portion of torque from the first output rotating member to the second output rotating member. The screw mechanism is configured to convert rotational motion of the electric motor into linear motion. The screw mechanism includes a nut member. The transmitting mechanism is configured to transmit linear motion force from the screw mechanism to the high-low switching mechanism and the clutch. The transmitting mechanism is arranged such that the transmitting mechanism moves inside an axial hole formed in the first output rotating member. The transmitting mechanism includes a fork shaft. The fork shaft is configured to connect the high-low sleeve and the nut member such that the high-low sleeve and the nut member operatively link.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a view schematically showing the structure of a vehicle according to one example embodiment, and illustrates the main portions of a control system for various controls in the vehicle;

FIG. 2 is a sectional view schematically showing the structure of a transfer, and illustrates the manner for switching to a 4WD running state in a high-speed gear;

FIG. 3 is a skeleton view schematically showing the structure of the transfer;

FIG. 4 is an enlarged sectional view of the area around a high-low switching mechanism shown in FIG. 2;

FIG. 5 is an enlarged sectional view of the area around a front-wheel drive clutch shown in FIG. 2; and

FIG. 6 is a sectional view schematically showing the structure of a transfer, and illustrates the manner for switching to a 4WD running state in a center differential locked state in a low-speed gear.

### DETAILED DESCRIPTION OF EMBODIMENTS

Hereinafter, example embodiments will be described with reference to the accompanying drawings. The drawings described in the example embodiments below have been simplified or modified as appropriate, so the scale ratios and the shapes and the like of the portions are not always accurately depicted.

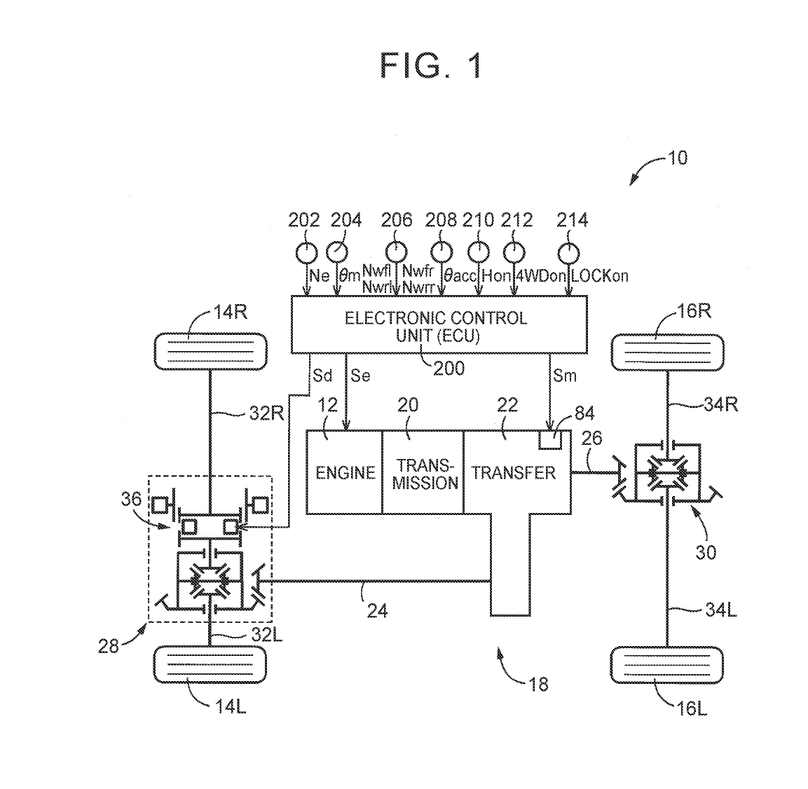

FIG. 1 is a view schematically showing the structure of a vehicle 10 in this example embodiment, and illustrates the main portions of a control system for various controls in the vehicle 10. As shown in FIG. 1, the vehicle 10 includes an engine 12 as a driving force source, left and right front wheels 14L, 14R (simply referred to as “front wheels 14” unless otherwise specified), left and right rear wheels 16L, 16R (simply referred to as “rear wheels 16” unless otherwise specified), and a power transmitting apparatus 18 that transmits power from the engine 12 to the front wheels 14 and the rear wheels 16, and the like. The rear wheels 16 are main driving wheels that are driving wheels both when running in two-wheel drive (2WD) and in four-wheel drive (4WD). The front wheels 14 are auxiliary driving wheels that are driven wheels when running in 2WD and are driving wheels when running in 4WD. Thus, the vehicle 10 is a front engine rear wheel drive (FR)-based four-wheel drive vehicle. The front wheels 14 are examples of second left and right wheels, and the rear wheels 16 are examples of first left and right wheels.

The power transmitting apparatus 18 includes a transmission 20, a vehicle transfer 22 (hereinafter, simply referred to as “transfer 22”), a front propeller shaft 24, a rear propeller shaft 26, a front wheel differential gear unit 28, a rear wheel differential gear unit 30, left and right front wheel axles 32L, 32R (simply referred to as “front wheel axles 32” unless otherwise specified), and left and right rear wheel axles 34L, 34R (simply referred to as “rear wheel axles 34” unless otherwise specified), and the like. The transmission 20 is connected to the engine 12. The transfer 22 is a front-rear wheel power transfer that is connected to the transmission 20. The front propeller shaft 24 and the rear propeller shaft 26 are both connected to the transfer 22. The front wheel differential gear unit 28 is connected to the front propeller shaft 24. The rear wheel differential gear unit 30 is connected to the rear propeller shaft 26. The front wheel axles 32 are connected to the front wheel differential gear unit 28. The rear wheel axles 34 are connected to the rear wheel differential gear unit 30. In the power transmitting apparatus 18 structured in this way, power from the engine 12 that has been transmitted to the transfer 22 via the transmission 20 is then transmitted from the transfer 22 to the rear wheels 16 via a power transmitting path on the rear wheel side. The power transmitting path on the rear wheel side includes the rear propeller shaft 26, the rear wheel differential gear unit 30, and the rear wheel axles 34 and the like in this order. Also, some of the power from the engine 12 that is to be transmitted to the rear wheel 16 side is distributed to the front wheel 14 side by the transfer 22, and then transmitted to the front wheels 14 via a power transmitting path on the front wheel side. The power transmitting path on the front wheel side includes the front propeller shaft 24, the front wheel differential gear unit 28, and the front wheel axles 32 and the like in this order.

The front wheel differential gear unit 28 includes a front-side clutch 36 on the front wheel axle 32R side (i.e., between the front wheel differential gear unit 28 and the front wheel 14R). The front-side clutch 36 is a dog clutch (i.e., a mesh-type clutch) that is electrically (electromagnetically) controlled and selectively establishes or interrupts the power transmitting path between the front wheel differential gear unit 28 and the front wheel 14R. The front-side clutch 36 may also be provided with a synchronizing mechanism (synchro mechanism).

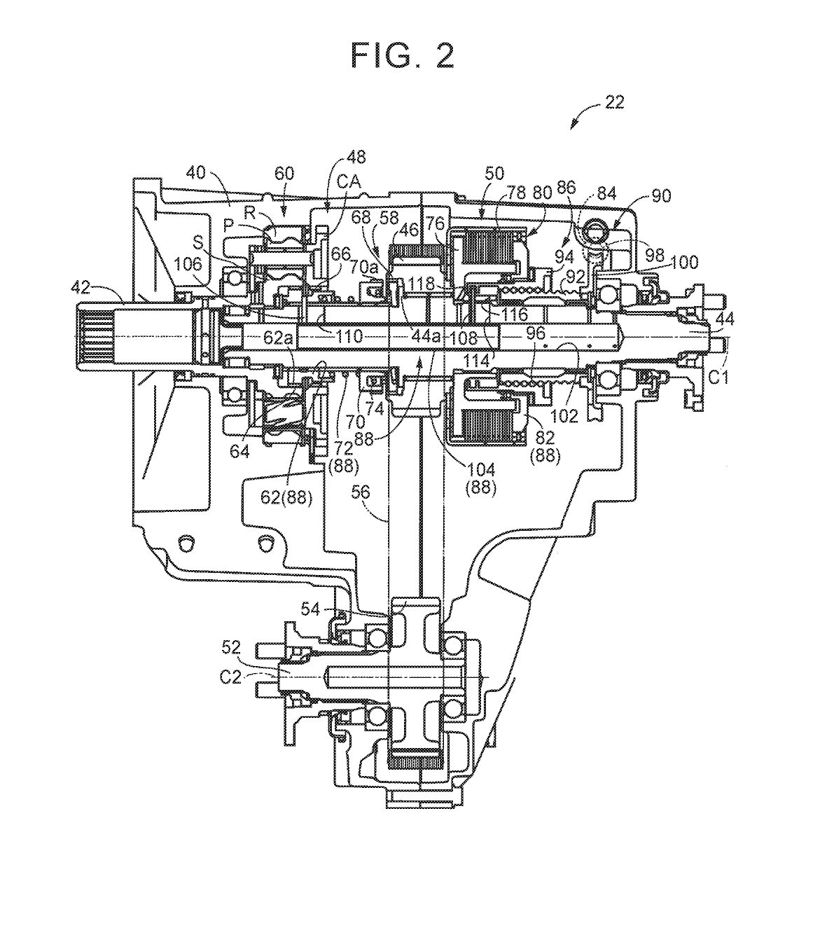

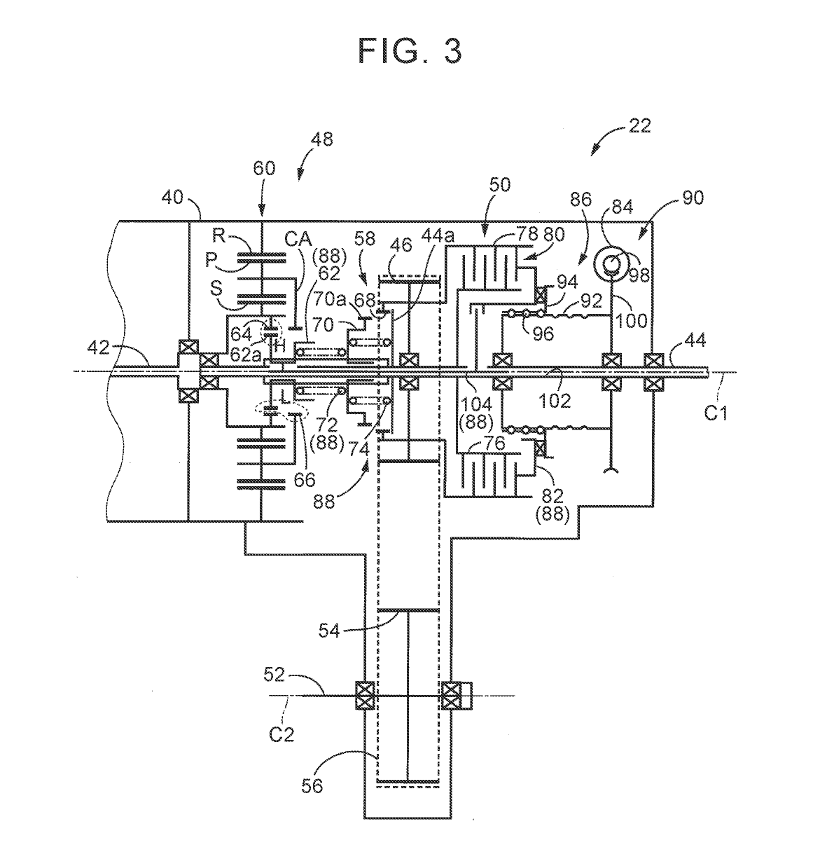

FIG. 2 and FIG. 3 are views schematically showing the structure of the transfer 22. FIG. 2 is a sectional view of the transfer 22. FIG. 3 is a skeleton view of the transfer 22. As shown in FIG. 2 and FIG. 3, the transfer 22 includes a transfer case 40 as a non-rotating member. The transfer 22 includes, inside the transfer case 40 and all around a common axis C1, an input shaft 42, a rear-wheel side output shaft 44, a drive gear 46, a high-low switching mechanism 48 and a front-wheel drive clutch 50. The input shaft 42 is an example of an input rotating member. The rear-wheel side output shaft 44 outputs power to the rear wheels 16. The rear-wheel side output shaft 44 is an example of a first output rotating member. The drive gear 46 outputs power to the front wheels 14. The drive gear 46 is an example of a second output rotating member. The high-low switching mechanism 48 changes the rate of rotation input from the input shaft 42 and transmits the resultant rotation to the rear-wheel side output shaft 44. The high-low switching mechanism 48 is an example of an auxiliary transmission., The front-wheel drive clutch 50 is a wet type multiple disc clutch that transmits some of the torque from the rear-wheel side output shaft 44 to the drive gear 46. The front-wheel drive clutch 50 is an example of a multiple disc clutch. Also, the transfer 22 includes, inside the transfer case 40 and around a common axis C2, a front-wheel side output shaft 52, and a driven gear 54 integrally provided on the front-wheel side output shaft 52. The transfer 22 also includes, inside the transfer case 40, a front-wheel drive chain 56 that connects the drive gear 46 to the driven gear 54, and a differential locking mechanism 58 that integrally connects (i.e., locks) the rear-wheel side output shaft 44 to the drive gear 46. The differential locking mechanism 58 is an example of a dog clutch.

The input shaft 42 is connected to an output rotating member, not shown, of the transmission 20, via a spline engagement coupling or the like, and is rotatably driven by driving force (torque) input from the engine 12 via the transmission 20. The rear-wheel side output shaft 44 is a main drive shaft that is connected to the rear propeller shaft 26. The drive gear 46 is provided on the rear-wheel side output shaft 44 in a manner so as to be able to rotate relative to the rear-wheel side output shaft 44. The front-wheel side output shaft 52 is an auxiliary drive shaft that is connected to the front propeller shaft 24.

The transfer 22 structured in this way adjusts the torque transmitted to the drive gear 46, and transmits the power transmitted from the transmission 20 to only the rear wheels 16, or to both the front wheels 14 and the rear wheels 16, for example. Also, the transfer 22 switches between a differential state (a so-called center differential unlocked state) that allows differential rotation between the rear propeller shaft 26 and the front propeller shaft 24, and a non-differential state (a so-called center differential locked state) that prevents differential rotation between these, for example. Also, the transfer 22 establishes one of a high-speed gear (a high-speed speed) H and a low-speed gear (a low-speed speed) L, and changes the rate of rotation input from the transmission 20 and transmits the resultant rotation downstream, for example. That is, the transfer 22 transmits the rotation of the input shaft 42 to the rear-wheel side output shaft 44 via the high-low switching mechanism 48. Also, when transfer torque through the front-wheel drive clutch 50 is zero and the differential locking mechanism 58 is released, power is not transmitted from the rear-wheel side output shaft 44 to the front-wheel side output shaft 52. On the other hand, when torque is transmitted through the front-wheel drive clutch 50 or the differential locking mechanism 58 is engaged, power is transmitted from the rear-wheel side output shaft 44 to the front-wheel side output shaft 52 via the drive gear 46, the front-wheel drive chain 56, and the driven gear 54.

The high-low switching mechanism 48 includes a single pinion planetary gear set 60 and a high-low sleeve 62. The planetary gear set 60 includes a sun gear S that is connected to the input shaft 42 and is able to rotate around the axis C1, a ring gear R that is arranged centered around the axis C1 on the outer peripheral side of the sun gear S and is connected to the transfer case 40 that is a non-rotatable member, in a state unable to rotate around the axis C1, and a carrier CA that rotatably supports a plurality of pinion gears P that are in mesh with the sun gear S and the ring gear R, in a manner that enables the pinion gears P to revolve around the axis C1. Accordingly, the rotation speed of the sun gear S is the same as that of the input shaft 42, and the rotation speed of the carrier CA is slower than that of the input shaft 42. High-side gear teeth 64 are fixed on an inner peripheral surface of this sun gear S, and low-side gear teeth 66 of the same diameter as the high-side gear teeth 64 are fixed on the carrier CA. The high-side gear teeth 64 are spline teeth that output rotation at the same speed as the input shaft 42 and are involved with establishing the high-speed gear H. The low-side gear teeth 66 are spline teeth that output rotation at a slower speed than the high-side gear teeth 64 and are involved with establishing the low-speed gear L.

The high-low sleeve 62 is spline engaged with the rear-wheel side output shaft 44 in a manner able to move in a direction parallel to the axis C1 relative to the rear-wheel side output shaft 44. The high-low sleeve 62 has outer peripheral teeth 62a that are able to mesh with the high-side gear teeth 64 and the low-side gear teeth 66 by the high-low sleeve 62 moving in the direction parallel to the axis C1 of the rear-wheel side output shaft 44. Rotation at the same speed as the rotation of the input shaft 42 is transmitted to the rear-wheel side output shaft 44 when the outer peripheral teeth 62a are in mesh with the high-side gear teeth 64. Rotation at a slower speed than the rotation of the input shaft 42 is transmitted to the rear-wheel side output shaft 44 when the outer peripheral teeth 62a are in mesh with the low-side gear teeth 66. The high-side gear teeth 64 and the high-low sleeve 62 function as a high-speed gear clutch for establishing the high-speed gear H, and the low-side gear teeth 66 and the high-low sleeve 62 function as a low-speed gear clutch for establishing the low-speed gear L. Hereinafter, the direction of the axis C1 of the rear-wheel side output shaft 44 will simply be referred to as the axis C1 direction.

The differential locking mechanism 58 is provided between the high-low switching mechanism 48 and the drive gear 46 in the axis C1 direction. The differential locking mechanism 58 has locking teeth 68 fixed on an inner peripheral surface of the drive gear 46, and a locking sleeve 70 that is splined engaged with the rear-wheel side output shaft 44 so as to be able to move in the direction parallel to the axis C1 relative to the rear-wheel side output shaft 44, and that has, fixed to an outer peripheral surface thereof, outer peripheral teeth 70a that mesh with the locking teeth 68 when the locking sleeve 70 moves in the direction parallel to the axis C1. In the transfer 22, when the differential locking mechanism 58 is in an engaged state in which the outer peripheral teeth 70a of the locking sleeve 70 are in mesh with the locking teeth 68, differential rotation between the rear-wheel side output shaft 44 and the drive gear 46 is restricted and the rear-wheel side output shaft 44 and the drive gear 46 rotate together as a unit, such that the center differential locked state is established.

The high-low sleeve 62 is provided in a space between the planetary gear set 60 and the drive gear 46 in the axis C1 direction. The locking sleeve 70 is provided in the space between the high-low sleeve 62 of the high-low switching mechanism 48 and the drive gear 46 in the axis C1 direction. The transfer 22 is provided with a first spring 72 between the high-low sleeve 62 and the locking sleeve 70. This first spring 72 is abutted against the high-low sleeve 62 and locking sleeve 70, and urges the high-low sleeve 62 and the locking sleeve 70 away from each other. The transfer 22 is also provided with a second spring 74 between the drive gear 46 and the locking sleeve 70. This second spring 74 is abutted against a protruding portion 44a of the rear-wheel side output shaft 44 and the locking sleeve 70, and urges the locking sleeve 70 toward the side away from the locking teeth 68. The protruding portion 44a is a flange portion of the rear-wheel side output shaft 44 that is provided protruding toward the radial outside in a space formed to the radially inner side of the drive gear 46.

The high-side gear teeth 64 are provided in a position farther away from the locking sleeve 70 than the low-side gear teeth 66 in the axis C1 direction. The outer peripheral teeth 62a of the high-low sleeve 62 mesh with the high-side gear teeth 64 on the side where the high-low sleeve 62 moves away from the locking sleeve 70 in the axis C1 direction (i.e., on the left side in FIGS. 2 and 3), and mesh with the low-side gear teeth 66 on the side where the high-low sleeve 62 moves toward the locking sleeve 70 in the axis C1 direction (i.e., on the right side in FIGS. 2 and 3). Also, the outer peripheral teeth 70a of the locking sleeve 70 mesh with the locking teeth 68 on the side where the locking sleeve 70 moves toward the drive gear 46 in the axis C1 direction (i.e., on the right side in FIGS. 2 and 3). Therefore, the outer peripheral teeth 70a of the locking sleeve 70 mesh with the locking teeth 68 when the high-low sleeve 62 is in the position in which the outer peripheral teeth 62a of the high-low sleeve 62 are in mesh with the low-side gear teeth 66.

More specifically, when the high-low sleeve 62 moves in the axis C1 direction to a position where the outer peripheral teeth 62a and the low-side gear teeth 66 are in mesh, the locking sleeve 70 is pressed toward the drive gear 46 side in the axis C1 direction by the first spring 72. Here, the urging force of the first spring 72 is set to a larger value than the urging force of the second spring 74, such that the locking sleeve 70 is moved toward the drive gear 46 side in the axis C1 direction against the urging force of the second spring 74, and the outer peripheral teeth 70a of the locking sleeve 70 mesh with the locking teeth 68.

The front-wheel drive clutch 50 is a wet type multiple disc friction clutch that includes a clutch hub 76 that is connected to the rear-wheel side output shaft 44 in a manner unable to rotate relative to the rear-wheel side output shaft 44, a clutch drum 78 that is connected to the drive gear 46 in a manner unable to rotate relative to the drive gear 46, a friction engagement element 80 that is interposed between the clutch hub 76 and the clutch drum 78 and selectively engages and disengages the clutch hub 76 and the clutch drum 78, and a piston 82 that presses on the friction engagement element 80. The front-wheel drive clutch 50 is arranged on the opposite side of the drive gear 46 with respect to the high-low switching mechanism 48 in the axis C1 direction. The front-wheel drive clutch 50 is placed in a released state when the piston 82 is moved toward the non-pressing side (i.e., the right side in FIGS. 2 and 3) that is the side away from the friction engagement element 80 in the axis C1 direction, and is not abutting against the friction engagement element 80. On the other hand, the front-wheel drive clutch 50 is placed in a slip state or an engaged state (a firmly connected state) by the transfer torque (torque capacity) being adjusted by the amount of movement of the piston 82, when the piston 82 is moved toward the pressing side (i.e., the left side in FIGS. 2 and 3) that is the side closer to the drive gear 46 in the axis C1 direction, and is abutting against the friction engagement element 80.

When the front-wheel drive clutch 50 is in the released state and the differential locking mechanism 58 is in a released state in which the outer peripheral teeth 70a of the locking sleeve 70 are not in mesh with the locking teeth 68, the power transmitting path between the rear-wheel side output shaft 44 and the drive gear 46 is interrupted such that the transfer 22 transmits the power transmitted from the transmission 20 to only the rear wheels 16. When the front-wheel drive clutch 50 is in the slip state or the engaged state, the transfer 22 distributes the power transmitted from the transmission 20 to both the front wheels 14 and the rear wheels 16. When the front-wheel drive clutch 50 is in the slip state, differential rotation is allowed between the rear-wheel side output shaft 44 and the drive gear 46, such that the differential state (the center differential unlocked state) is established in the transfer 22. When the front-wheel drive clutch 50 is in the engaged state, differential rotation between the rear-wheel side output shaft 44 and the drive gear 46 is restricted and the rear-wheel side output shaft 44 and the drive gear 46 rotate together as a unit, such that the center differential locked state is established in the transfer 22. The front-wheel drive clutch 50 is able to continuously change the torque distribution between the front wheels 14 and the rear wheels 16 between 0:100 and 50:50, for example, by adjusting (controlling) the transfer torque.

The transfer 22 also includes, as an apparatus that operates the high-low switching mechanism 48, the front-wheel drive clutch 50, and the differential locking mechanism 58, an electric motor 84, a screw mechanism 86 that converts the rotational motion of the electric motor 84 into linear motion, and a transmitting mechanism 88 that transmits the linear motion force of the screw mechanism 86 to the high-low switching mechanism 48, the front-wheel drive clutch 50, and the differential locking mechanism 58.

The screw mechanism 86 is arranged around the same axis C1 as the rear-wheel side output shaft 44, and includes a threaded shaft member 92 as a rotating member that is indirectly connected to the electric motor 84 via a worm gear 90 provided in the transfer 22, and a nut member 94 as a linear motion member that is connected to the threaded shaft member 92 so as to be able to move in the axis C1 direction of the rear-wheel side output shaft 44 as the threaded shaft member 92 rotates. The screw mechanism 86 is a ball screw in which the threaded shaft member 92 and the nut member 94 operate via multiple balls 96. The worm gear 90 is a gear pair that includes a worm 98 integrally formed on an electric motor shaft of the electric motor 84, and a worm wheel 100 that is arranged around the axis C1 and integrally formed on the threaded shaft member 92. For example, the rotation from the electric motor 84 that is a brushless motor is reduced in speed and transmitted to the threaded shaft member 92 via the worm gear 90. The screw mechanism 86 converts the rotation of the electric motor 84 transmitted to the threaded shaft member 92 into linear motion of the nut member 94.

The transmitting mechanism 88 includes a fork shaft 104 that is arranged in an axial hole 102 that is parallel to the axis C1 inside the rear-wheel side output shaft 44, and that operably connects the high-low sleeve 62 to the nut member 94, and a first pin 106 and a second pin 108 that are connected in states extending toward the radial outside from the outer peripheral surface of the fork shaft 104. The first pin 106 and the second pin 108 are provided one on each side of fork shaft 104 in the axial direction.

The axial hole 102 that is parallel to the axis C1 is formed centered around the axis C1 in the rear-wheel side output shaft 44. The fork shaft 104 has a cylindrical shape, and is arranged in a state able to move in the axis C1 direction inside the axial hole 102. A plurality of holes that communicate the inside of the cylindrical shape with the outside of the cylindrical shape are formed in the fork shaft 104, and lubricating oil supplied to the axial hole 102 is supplied to a lubricating oil passage formed in the rear-wheel side output shaft 44 through these holes.

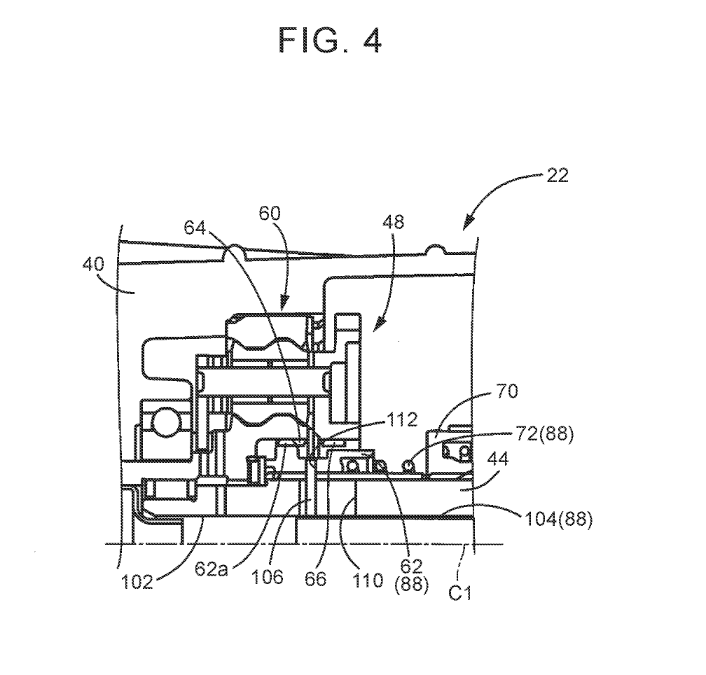

FIG. 4 is an enlarged sectional view of the area around the high-low switching mechanism 48 shown in FIG. 2. The first pin 106 has a circular cross-section, and is provided in a position overlapping with the high-low sleeve 62 that forms the high-low switching mechanism 48, when viewed from the radial outside of the rear-wheel side output shaft 44. The first pin 106 extends toward the radial outside from the outer peripheral surface of the rear-wheel side output shaft 44, and passes in the radial direction through a first through-hole 110 formed in the rear-wheel side output shaft 44. Moreover, the first pin 106 is engaged with an engaging hole 112 formed in the high-low sleeve 62. Therefore, the high-low sleeve 62 is prevented from moving relative to the first pin 106 in the axis C1 direction, and rotates together with the first pin 106 as a single unit. As a result, the first pin 106 functions as a member that makes up a portion of the transmitting mechanism 88.

The first through-hole 110 passes in the radial direction through a wall surface of the axial hole 102 of the rear-wheel side output shaft 44 and the outer peripheral surface of the rear-wheel side output shaft 44. When the first through-hole 110 is viewed from the radial outside of the rear-wheel side output shaft 44, the first through-hole 110 is formed elongated in the axis C1 direction so as to allow the first pin 106 that passes through the first through-hole 110 to move in the axis C1 direction relative to the rear-wheel side output shaft 44. Also, the dimension of the first through-hole 110 in the circumferential direction when the rear-wheel side output shaft 44 is viewed from the radial outside is set to a dimension slightly larger than the cross-sectional diameter of the first pin 106. Therefore, the first pin 106 is able to move relative to the rear-wheel side output shaft 44 by the dimension in the axis C1 direction of the first through-hole 110. The dimension in the axis C1 direction of the first through-hole 110 is set to a dimension that allows an H4L running mode, described later, that is a running mode in which the first pin 106 is moved farthest to the input shaft 42 side in the axis C1 direction, and a L4L running mode, described later, that is a running mode in which the first pin 106 is moved in the direction farthest away from the input shaft 42 in the axis C1 direction.

Also, the radial outside of the first pin 106 is engaged with the engaging hole 112 of the high-low sleeve 62. Therefore, the first pin 106 is restricted from both moving and rotating relative to the high-low sleeve 62 in the axis C1 direction. Accordingly, when the fork shaft 104 moves in the axis C1 direction, the high-low sleeve 62 moves via the first pin 106 in the axis C1 direction in conjunction with the fork shaft 104. That is, the position of the high-low sleeve 62 in the axis C1 direction is adjusted according to the position of the fork shaft 104 in the axis C1 direction.

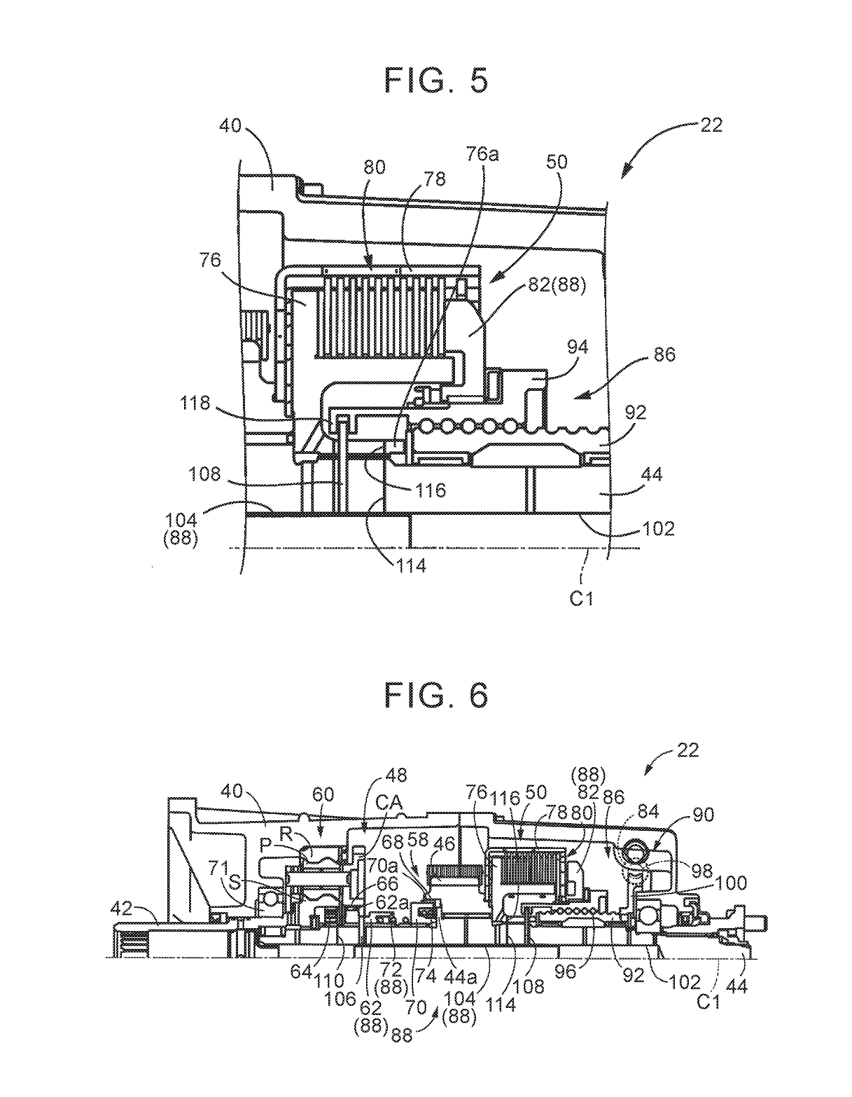

FIG. 5 is an enlarged sectional view of the area around the front-wheel drive clutch 50 shown in FIG. 2. The second pin 108 has a circular cross-section, and is provided in a position overlapping with a portion of the nut member 94 in the radial direction, when viewed from the radial outside of the rear-wheel side output shaft 44. The second pin 108 extends toward the radial outside from the outer peripheral surface of the rear-wheel side output shaft 44, and passes in the radial direction through a second through-hole 114 fowled in the rear-wheel side output shaft 44 and a third through-hole 116 formed in the clutch hub 76. Also, a radial outside end portion of the second pin 108 is engaged with an engaging portion 118 that extends from the nut member 94.

The second through-hole 114 passes in the radial direction through a wall surface of the axial hole 102 of the rear-wheel side output shaft 44 and the outer peripheral surface of the rear-wheel side output shaft 44. When the second through-hole 114 is viewed from the radial outside of the rear-wheel side output shaft 44, the second through-hole 114 is formed elongated in the axis C1 direction so as to allow the second pin 108 that passes through the second through-hole 114 to move in the axis C1 direction relative to the rear-wheel side output shaft 44. Also, the dimension of the second through-hole 114 in the circumferential direction when the rear-wheel side output shaft 44 is viewed from the radial outside is set to a dimension slightly larger than the cross-sectional diameter of the second pin 108. Therefore, the second pin 108 is able to move relative to the rear-wheel side output shaft 44 by the dimension in the axis C1 direction of the second through-hole 114.

The third through-hole 116 passes in the radial direction through a cylindrical portion formed on the clutch hub 76. When the third through-hole 116 is viewed from the radial outside of the clutch hub 76, the third through-hole 116 is formed elongated in the axis C1 direction so as to allow the second pin 108 that passes through the third through-hole 116 to move in the axis C1 direction relative to the rear-wheel side output shaft 44. Also, the dimension in the circumferential direction of the third through-hole 116 when the clutch hub 76 is viewed from the radial outside is set to a dimension slightly larger than the cross-sectional diameter of the second pin 108. Therefore, the second pin 108 is able to move relative to the rear-wheel side output shaft 44 by the dimension in the axis C1 direction of the third through-hole 116. Also, the rear-wheel side output shaft 44 and the clutch hub 76 are spline-fitted together and thus rotate together as a single unit, so the second through-hole 114 and the third through-hole 116 are in positions that always overlap when viewed from the radial outside of the rear-wheel side output shaft 44. The dimensions of the second through-hole 114 and the third through-hole 116 in the axis C1 direction are set to dimensions that allow an H4L running mode, described later, that is a running mode in which the second pin 108 is moved farthest to the input shaft 42 side in the axis C1 direction, and a L4L running mode, described later, that is a running mode in which the second pin 108 is moved in the direction farthest away from the input shaft 42 in the axis C1 direction.

The radial outside of the second pin 108 is engaged with an engaging portion 118 formed on the drive gear 46 side in the axis C1 direction of the nut member 94. The engaging portion 118 has a U-shaped cross-section and is formed in an annular shape in the circumferential direction. Therefore, the second pin 108 and the engaging portion 118 are in an engaged state regardless of the position of the second pin 108 in the rotational direction. Thus, when the nut member 94 moves in the axis C1 direction of the rear-wheel side output shaft 44, the second pin 108 that is engaged with the engaging portion 118, and the fork shaft 104, will also move in the axis C1 direction. Hence, the engaging portion 118 functions as a member that forms a portion of the transmitting mechanism 88.

According to FIG. 1, an electronic control unit (ECU) 200 that includes a control apparatus of the vehicle 10 that switches between a 2WD running state and a 4WD running state, for example, is provided in the vehicle 10. The ECU 200 includes a so-called microcomputer that includes, for example, a CPU, RAM, ROM, and an input/output interface and the like. The CPU executes various controls of the vehicle 10 by processing signals according to a program stored in advance in the ROM, while using the temporary storage function of the RAM.

For example, the ECU 200 executes output control of the engine 12, and switching control to switch the driving state of the vehicle 10, and the like, and is formed divided into sections for engine control and driving state control and the like as necessary. As shown in FIG. 1, various actual values based on detection signals from various sensors provided in the vehicle 10 are supplied to the ECU 200. Examples of such actual values include an engine speed Ne, a motor rotation angle θm, wheel speeds Nwfl, Nwfr, Nwrl, Nwrr of the front wheels 14L, 14R and the rear wheels 16L, 16R, an accelerator operation amount θacc, an H-range request Hon that is a signal indicating that an H-range selector switch 210 has been operated, a 4WD request 4WDon that is a signal indicating that a 4WD selector switch 212 has been operated, and LOCKon that is a signal indicating that a differential lock selector switch 214 has been operated, and the like. Examples of the various sensors include an engine speed sensor 202, a motor rotation angle sensor 204, wheel speed sensors 206, an accelerator operation amount sensor 208, a H-range selector switch 210 for selecting the high-speed gear H in response to an operation by the driver, the 4WD selector switch 212 for selecting the 4WD running state in response to an operation by the driver, and the differential lock selector switch 214 for selecting the center differential locked state in response to an operation by the driver, and the like.

Various signals, for example, an engine output control command signal Se for output control of the engine 12, an operation command signal Sd for switching the state of the front-side clutch 36, and a motor drive command signal Sm for controlling the rotation amount of the electric motor 84, and the like, are output from the ECU 200 to an output control apparatus of the engine 12, an actuator of the front-side clutch 36, and the electric motor 84 and the like, respectively, as shown in FIG. 1.

In the vehicle 10 structured as described above, the amount of movement (i.e., the stroke) of the nut member 94 is controlled by controlling the rotation amount of the electric motor 84. The vehicle 10 is switched to a 2WD running state in which the front-wheel drive clutch 50 is released, the high-low switching mechanism 48 in kept in the high-speed gear H, and only the rear wheels 16 are driven (this running state will be referred to as an “H2 running mode”), by driving the electric motor 84 a predetermined rotation amount to move the nut member 94 by a predetermined stroke amount toward the non-pressing side from a position in which the piston 82 is abutted against the friction engagement element 80. That is, in the H2 running mode, the high-low switching mechanism 48 is switched to the high-speed gear, and the front-wheel drive clutch is released by adjusting the position of the nut member 94 in the axial direction by controlling the rotation amount of the electric motor 84. The fork shaft 104 moves inside the axial hole 102 in conjunction with the nut member 94 via the engaging portion 118 and the second pin 108. Furthermore, the high-low sleeve 62 is moved in the axis C1 direction via the engaging hole 112 and the first pin 106 that is connected to the fork shaft 104, and moves to a position where the outer peripheral teeth 62a of the high-low sleeve 62 remain in mesh with the high-side gear teeth 64. Therefore, the high-low switching mechanism 48 is kept in the high-speed gear H. The piston 82 transmits the linear motion force of the screw mechanism 86 to the front-wheel drive clutch 50, and thus functions as a portion of the transmitting mechanism 88.

Also, in the H2 running mode, the front-side clutch 36 is released, and rotation is not transmitted from either the engine 12 side or the front wheel 14 side to the rotating elements (e.g., the drive gear 46, the front-wheel drive chain 56, the driven gear 54, the front-wheel side output shaft 52, the front propeller shaft 24, and the front wheel differential gear unit 28) that form the power transmitting path from the drive gear 46 to the front wheel differential gear unit 28, while running in 2WD. Therefore, while running in 2WD, these rotating elements are stopped from rotating and thus are prevented from being dragged along, so running resistance is reduced.

Also, as shown in FIGS. 2, 4, and 5, for example, the vehicle 10 is switched to a 4WD running state in which the high-low switching mechanism 48 is kept in the high-speed gear H and power is transmitted to both the front wheels 14 and the rear wheels 16 (this running mode will be referred to as an “H4 running mode”), by placing the front-wheel drive clutch 50 in the slip state by controlling the rotation amount of the electric motor 84 to move the nut member 94 toward the pressing side from a position where the piston 82 abuts against the friction engagement element 80. In this H4 running mode, torque distribution between the front wheels 14 and the rear wheels 16 is adjusted as necessary by adjusting the transfer torque of the front-wheel drive clutch 50.

The fork shaft 104 moves the axial hole 102 in conjunction with the nut member 94, and the fork shaft 104 and the high-low sleeve 62 are moved farther toward the input shaft 42 side in the axis C1 direction than they are in the H2 running mode. Also, the high-low sleeve 62 is operatively linked to the fork shaft 104 via the second pin 108, and is thus moved farther toward the input shaft 42 side in the axis C1 direction of the rear-wheel side output shaft 44 than it is in the H2 running mode. Here, the high-side gear teeth 64 that are formed on the sun gear S are formed having a length whereby they mesh with the outer peripheral teeth 62a of the high-low sleeve 62 in both the H2 running mode and the H4 running mode, so the high-side gear teeth 64 are in mesh with the outer peripheral teeth 62a in the H4 running mode as well. Therefore, the high-low switching mechanism 48 is kept in the high-speed gear H.

Also, the vehicle 10 is switched to a 4WD running state in the center differential locked state, in which the high-low switching mechanism 48 is kept in the high-speed gear H (this running state will be referred to as an “H4L running mode”), by firmly connecting (completely engaging) the front-wheel drive clutch 50 by controlling the rotation amount of the electric motor 84 to move the nut member 94 even farther toward the pressing side than it is in the H4 running mode. The difference between the amount of movement of the nut member 94 in the axis C1 direction in the H4 running mode and the H4L running mode is slight, so the H4L running mode is almost the same as the H4 running mode shown in FIGS. 2 to 4. In the H4L running mode, the fork shaft 104 is moved farthest toward the input shaft 42 side in the axis C1 direction of the rear-wheel side output shaft 44. Also, the high-low sleeve 62 is also moved farthest toward the input shaft 42 side in the axis C1 direction, and the meshing of the high-side gear teeth 64 and the outer peripheral teeth 62a is maintained. In the H4L running mode, the nut member 94, the first pin 106, the second pin 108, and the high-low sleeve 62 are moved toward the input shaft 42 side in the axis C1 direction.

Also, a 4WD running state in which the front-wheel drive clutch 50 is released, and the differential locking mechanism 58 is engaged, i.e., the outer peripheral teeth 70a of the locking sleeve 70 are in mesh with the locking teeth 68 of the drive gear 46, and moreover, the high-low switching mechanism 48 is switched to the low-speed gear L (this running state will be referred to as an “L4L running mode”), is established by controlling the rotation amount of the electric motor 84 to move the nut member 94 farther to the side away from the input shaft 42 in the axis C1 direction than it is in the H2 running mode, as shown in FIG. 6. In this L4L running mode, the fork shaft 104 is moved farther toward the side away from the input shaft 42 in the axis C1 direction of the rear-wheel side output shaft 44 than it is in the H2 running mode, in conjunction with the nut member 94. Also, the high-low sleeve 62 is also similarly moved farther toward the drive gear 46 side in the axis C1 direction than it is in the H2 running mode, in conjunction with the fork shaft 104, such that the outer peripheral teeth 62a of the high-low sleeve 62 mesh with the low-side gear teeth 66 of the carrier CA. Therefore, the high-low switching mechanism 48 is switched to the low-speed gear L.

Furthermore, as a result of the high-low sleeve 62 being moved farthest to the drive gear 46 side in the axis C1 direction, the first spring 72 that abuts against the high-low sleeve 62 presses on the locking sleeve 70, and the locking sleeve 70 is consequently moved toward the drive gear 46 side in the axis C1 direction against the urging force of the second spring 74. As a result, the outer peripheral teeth 70a of the locking sleeve 70 mesh with the locking teeth 68, such that the differential locking mechanism 58 engages, thus establishing the center differential locked state in which the rear-wheel side output shaft 44 and the drive gear 46 rotate together as a single unit. In the L4L running mode, the nut member 94, the fork shaft 104, the first pin 106, the second pin 108, and the high-low sleeve 62 all move toward the side away from the input shaft 42 in the axis C1 direction. The first spring 72 and the high-low sleeve 62 that is operatively linked to the fork shaft 104 transmit the linear motion force of the screw mechanism 86 to the locking sleeve 70 that forms the differential locking mechanism 58, and thus functions as a portion of the transmitting mechanism 88.

As described above, vehicle transfer 22 switches the vehicle 10 among the H2 running mode, the H4 running mode, the H4L running mode, and the L4L running mode, by the fork shaft 104 that forms the transmitting mechanism 88 moving inside the axial hole 102 according to the position of the nut member 94, and the high-low sleeve 62 being moved in the axial direction in conjunction with the fork shaft 104. That is, the vehicle transfer 22 is configured to be able to switch the vehicle 10 to at least one of i) the H2 running mode in which the high-low switching mechanism 48 is switched to the high-speed gear and the front-wheel drive clutch 50 is released, ii) the H4 running mode or the H4L running mode in which the high-low switching mechanism 48 is switched to the high-speed gear and the transfer torque of the front-wheel drive clutch 50 is adjusted, and iii) the L4L running mode in which the high-low switching mechanism 48 is switched to the low-speed gear, and differential rotation between the rear-wheel side output shaft 44 and the drive gear 46 is restricted, by controlling the rotation amount of the electric motor 84 and adjusting the position of the nut member 94 in the axial direction. Also, the fork shaft 104 that forms the transmitting mechanism 88 and operatively links the nut member 94 and the high-low sleeve 62 is housed inside the axial hole 102 of the rear-wheel side output shaft 44, so space for providing the fork shaft 104 is no longer necessary.

As described above, according to this example embodiment, the fork shaft 104 arranged in the rear-wheel side output shaft 44 is connected to the high-low sleeve 62 of the high-low switching mechanism 48 and the nut member 94 of the screw mechanism 86 that adjusts the torque of the front-wheel drive clutch 50, so when the nut member 94 moves in the axis C1 direction, the high-low sleeve 62 moves in the axis C1 direction in conjunction with this via the fork shaft 104. Therefore, the switching of the high-low switching mechanism 48 and the torque adjustment of the front-wheel drive clutch 50 are able to be executed by the screw mechanism 86. Here, the fork shaft 104 is arranged in the axial hole 102 of the rear-wheel side output shaft 44, so space for providing the fork shaft 104 is unnecessary, which enables the vehicle transfer 22 to be smaller.

Also, according to this example embodiment, the first pin 106 that is connected to the fork shaft 104 is engaged with the engaging hole 112 of the high-low sleeve 62 in a manner unable to move relative thereto in the axis C1 direction, so the high-low sleeve 62 is able to move in the axis C1 direction in conjunction with the fork shaft 104. Moreover, the first through-hole 110 formed in the rear-wheel side output shaft 44 is formed elongated in the axis C1 direction when the rear-wheel side output shaft 44 is viewed from the radial outside, so the first pin 106 and the fork shaft 104 are able to move in the axis C1 direction relative to the rear-wheel side output shaft 44.

Also, according to this example embodiment, the second pin 108 that is connected to the fork shaft 104 is engaged with the engaging portion 118 of the nut member 94 of the screw mechanism 86, and is thus able to move the fork shaft 104 in the axis C1 direction in conjunction with the nut member 94. Also, the second through-hole 114 formed in the rear-wheel side output shaft 44 is formed elongated in the axis C1 direction when the rear-wheel side output shaft 44 is viewed from the radial outside, so the second pin 108 and the fork shaft 104 are able to move in the axis C1 direction relative to the rear-wheel side output shaft 44.

Heretofore, an example embodiment has been described in detail with reference to the drawings, but other example embodiments are also possible.

For example, the fork shaft 104 in the example embodiment described above is formed in a cylindrical shape, but the fork shaft 104 is not necessarily limited to a cylindrical shape. For example, the fork shaft 104 may also have a columnar shape or the like.

Also, in the example embodiment described above, the differential locking mechanism 58 is provided, but the differential locking mechanism 58 may also be omitted.

Also, in the example embodiment described above, the screw mechanism 86 includes the balls 96, but the balls 96 may also be omitted.

Also, in the example embodiment described above, the vehicle 10 is an FR-based four-wheel drive vehicle, but the vehicle transfer is not limited to an FR-based four-wheel drive vehicle and may also be applied to an FF (front engine front wheel drive)-based four-wheel drive vehicle, for example.

Also, in the example embodiment described above, the front wheel differential gear unit 28 has the front-side clutch 36 provided on the front wheel axle 32R side, and while running in 2WD, rotative power is not transmitted from either the engine 12 side or the front wheel 14 side to the rotating elements that form the power transmitting path from the drive gear 46 to the front wheel differential gear unit 28, so these rotating elements are stopped from rotating and thus are prevented from being dragged along. However, the vehicle transfer 22 may also be applied to a four-wheel drive vehicle that does not include the front-side clutch 36, and does not stop the rotating elements from rotating when running in 2WD.

Also, in the example embodiment described above, the front-wheel drive clutch 50 is a multiple disc clutch formed by a plurality of friction plates, but the vehicle transfer is not limited to a multiple disc clutch and may also be applied to a single disc clutch.

The example embodiments described above are no more than example embodiments. That is, the vehicle transfer may be carried out in modes that have been modified or improved in any of a variety of ways based on the knowledge of one skilled in the art.

What is claimed is:

1. A transfer for a vehicle, the vehicle including first left and right wheels, second left and right wheels, and an electric motor, the transfer comprising:
an input rotating member configured to rotate around an axis of the input rotating member;
a first output rotating member configured to output power to the first left and right wheels;
a second output rotating member configured to output power to the second left and right wheels;
a high-low switching mechanism configured to change a rate of rotation input from the input rotating member and transmit the resultant rotation to the first output rotating member, the high-low switching mechanism including a high-low sleeve;
a clutch configured to transmit a portion of torque from the first output rotating member to the second output rotating member;
a screw mechanism configured to convert rotational motion of the electric motor into linear motion, the screw mechanism including a nut member; and
a transmitting mechanism configured to transmit linear motion force from the screw mechanism to the high-low switching mechanism and the clutch, the transmitting mechanism arranged such that the transmitting mechanism moves inside an axial hole formed in the first output rotating member, the transmitting mechanism including a fork shaft, the fork shaft being configured to connect the high-low sleeve and the nut member such that the high-low sleeve and the nut member operatively link.

2. The transfer according to claim 1, wherein
the transmitting mechanism includes a first pin;
the first output rotating member has a first through-hole;
the high-low sleeve is arranged on an outer peripheral side of the first output rotating member;
the first pin extends toward a radial outside from an outer peripheral surface of the fork shaft, and the first pin is connected to the fork shaft;
the first pin passes through the first through-hole in a radial direction of the first output rotating member;
the first pin is engaged with the high-low sleeve such that the first pin and the high-low sleeve are configured not to move relative to each other in an axial direction of the first output rotating member; and
the first through-hole is provided elongated in the axial direction when the first output rotating member is viewed from the radial outside, such that the first pin and the fork shaft move in the axial direction relative to the first output rotating member.

3. The transfer according to claim 1, wherein
the transmitting mechanism includes a second pin;
the first output rotating member has a second through-hole;
the second pin extends toward a radial outside from an outer peripheral surface of the fork shaft, and the second pin is connected to the fork shaft;
the second pin passes through the second through-hole in a radial direction of the first output rotating member;
the second pin is engaged with the nut member such that the second pin and the nut member are configured not to move relative to each other in the axial direction of the first output rotating member; and
the second through-hole is provided elongated in the axial direction when the first output rotating member is viewed from the radial outside, such that the second pin and the fork shaft move in the axial direction relative to the first output rotating member.
